(19) United States
(12) Patent Application Publication
(10) Pub. No.: US 2005/0099243 A1
(43) Pub. Date: May 12, 2005

(54) Transmission line structure on base board

(76) Inventor: Ching-Wen Weng, Taipei (TW)

Correspondence Address: SUPREME PATENT SERVICES, POST OFFICE BOX 2339, SARATOGA, CA, 95070, US

(21) Appl. No.: 10/706,207

(22) Filed: Nov. 11, 2003

(51) Int. Cl. H01P 5/02

(52) U.S. Cl. 333/33

(57) ABSTRACT

A transmission line structure on base board is proposed to arrange an elliptical or, paper-clip shaped lead-wire wound pattern adjacent to the output end of every independent lead wire to thereby enlarge the area enclosed by the lead wires and accordingly to enhance the capacitance of the base board, compensate the circuit signals, and make shrinkage of the circuit board possible.

### BACKGROUND OF THE INVENTION

1. Field of the Invention

The present invention relates to a transmission line structure on circuit board, and in particular to a transmission line structure on circuit board composed of a plurality of horizontal and vertical capacitors between transmission lines.

2. The Prior Arts

“Cross-talk” is a known phenomenon that degrades the quality of signal transmission through transmission lines and couplings. It is especially conspicuous in the case of a high-frequency signal transmission process. For improvements, to change the configuration of couplings or add a metallic shield between transmission lines seemed the widely taken measures so far.

### SUMMARY OF THE INVENTION

Nevertheless, as the measures mentioned for eliminating cross-talk do not work very well on the one hand, the manufacture cost is raised and the process is complicated on the other hand, a transmission line structure on base board according to the present invention is provided in the hope of dissolving the existed defects.

In the transmission line structure, the lead wire of a base board is composed of a plurality of signal channels, in which every two channels forms a parity. To avoid any cross talk caused in each parity by interference of high-frequency signals, an elliptical or paper clip shaped lead-wire pattern is staggeringly provided to each corresponding parity so that a capacitance structure in the horizontal direction is formed between parities on the top and the bottom surface of the base board respectively, and another capacitance structure in the vertical direction is formed between pairs of elliptical lead-wire patterns located on different surfaces at corresponding positions on the base board.

The merits of the present invention may be summarized as the following:
(1) As horizontal and vertical capacitance structures can be formed on the base board of couplings, to enhance the capacitance between parities and accordingly to compensate the circuit signals, particularly for high-frequency circuits, is possible.
(2) Since the horizontal and the vertical capacitance structures are provided to the transmission line structure on base board of the present invention, the space of the base board can be fully used for a more dense layout of circuit and for shrinking the circuit board.

(3) Since the horizontal and the vertical capacitance structures are provided to the transmission line structure on base board of the present invention to eliminate “cross-talk”, all it requires is change the photo-mask on the base board to become compatible with the conventional process.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is an exploded view showing a practical embodiment of a transmission line structure on circuit board of the present invention;

FIG. 2 is an assembled view showing a practical embodiment of a transmission line structure on circuit board of the present invention;

FIG. 3A is a top view showing the circuit board in a practical embodiment of a transmission line's structure of the present invention; and

FIG. 3B is a bottom view showing the circuit board in a practical embodiment of a transmission line's structure of the present invention.

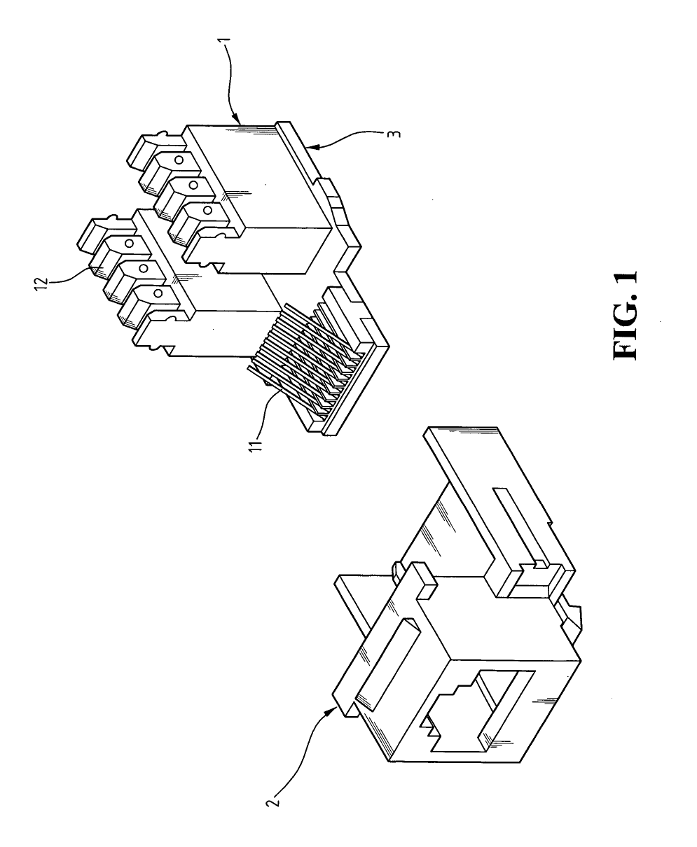

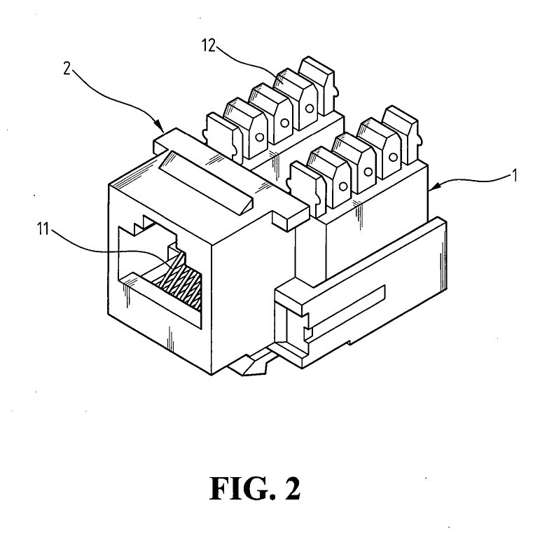

### DETAILED DESCRIPTION OF THE PREFERRED EMBODIMENT

A transmission line structure on circuit board of the present invention is provided with an additional lead wire fragment patterned in an ellipse or a paper-clip adjacent to the output end of the lead wire to hence expand the area enclosed thereby and accordingly enlarge the capacitance thereof for compensating the circuit signals.

A preferred embodiment of the transmission line structure on circuit board of the present invention comprises a wire-distributing base (1), which is provided with an I/O port (11) composed of a plurality of terminal pins (11a) at its front end for input/output of signals and a wire-distributing port (12) at its rear end for fixing transmission lines; a fixed block (2) for mating with the wire-distributing base (1); and a base board (3), which is a circuit board disposed beneath the wire-distributing base (1) for mating with the I/O port (11) and the wire-distributing port (12) to hence complete the electric connections with corresponding signal channels.

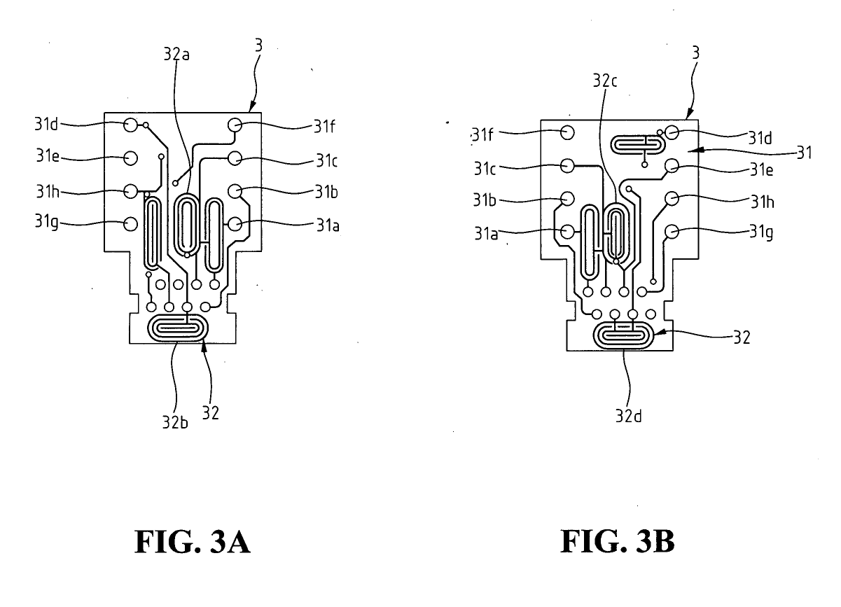

FIGS. 3A and 3B are plane views of the top and the bottom surface of the base board (3) in the transmission line structure on circuit board of the present invention. As shown in the drawings, a lead wire (31) of the base board (3) is composed of eight signal channels, in which a first parity comprises a first channel (31a) and a second channel (31b); a second parity comprises a third channel (31c) and a sixth channel (31f); a third parity comprises a fourth channel (31d) and a fifth channel (31e); and a fourth parity comprises a seventh channel (31g) and a eighth channel (31h). In order to avoid any cross-talk caused by interference of high-frequency signals in each parity, an elliptical or a paper-clip shaped lead-wire wound pattern (32) for each parity is defined and disposed staggeringly to each other on the base board (3) to thereby enlarge the capacitance between parities and accordingly compensate the circuit signals. That is, a first capacitor (32a) and a second capacitor (32b) are formed on the top surface while a third capacitor (32c) and a fourth capacitor (32d) are formed on the bottom surface of the base board (3). In other words, the first capacitor (32a) is created by extending the third channel (31c) and the fifth channel (31e) on the top surface of the base board (3) to form staggeringly disposed elliptical or paper-clip shaped lead-wire wound patterns (32), and the third capacitor (32c) is created by extending the third channel (31c) and the fifth channel (31e) on the bottom surface of the base board (3) to form staggeringly disposed elliptical or paper-clip shaped lead-wire wound patterns (32), such that a capacitance structure in the horizontal direction of the base board (3) is formed by the second and the third parity on the top and the bottom surface of the base board (3) respectively, and meanwhile, another capacitance structure in the vertical direction of the base board (3) is formed by the first capacitor (32a) and the third capacitor (32c). Similarly, the second capacitor (32b) is created by extending the fourth channel (31d) on the top surface of the base board (3) to form an elliptical or a paper-clip shaped lead-wire wound pattern (32), and the fourth capacitor (32d) is created by extending the fourth channel (31d) and the sixth channel (31f) to form staggeringly disposed elliptical or paper-clip shaped lead-wire wound patterns (32) on the bottom surface of the base board (3) such that a capacitance structure in the horizontal direction of the base board (3) is formed by the second and the third parity on the top and the bottom surface of the base board (3) respectively, and meanwhile, another capacitance structure in the vertical direction of the base board (3) is formed by the second capacitor (32b) and the fourth capacitor (32d). Therefore, the capacitance between the second and the third parity is enhanced to compensate the circuit signals.

In addition, it is possible to arrange more elliptical lead-wire patterns (32) between channels to obtain more capacitance effects between parities for solving the problems caused by cross-talk.

In the above described, at least one preferred embodiment has been described in detail with reference to the drawings annexed, and it is apparent that numerous changes or modifications may be made without departing from the true spirit and scope thereof, as set forth in the claims below.

1. A transmission line structure on base board, in which an extra elliptical or paper-clip shaped lead-wire pattern is disposed adjacent to the output end of every independent lead wire such that the area enclosed by the lead wire can be expanded for controlling the capacitance thereof and compensating the circuit signals accordingly.

2. The structure according to claim 1, in which first and second capacitors are formed respectively on a top and a bottom surface of the base board by a first and a second parity, in which the first capacitor is created by extending the first and second parity on the top surface of the base board to form staggeringly disposed lead-wire wound patterns, while the second capacitor is created by extending the first and second parity on the bottom surface of the base board to form staggeringly disposed lead-wire wound patterns, so that a horizontal capacitance structure is formed on the top and the bottom surface of the base board respectively, and a vertical capacitance structure is formed between the first and the second capacitor for compensating the circuit signals by enhancing the capacitance of the second and the third parity.

3. A transmission line structure on base board, in which the lead wire of a base board is composed of a plurality of signal channels; every two channels forms a parity in a paper-clip shaped lead-wire wound pattern suitably disposed on the base board; and all the parities are staggeringly disposed for controlling the capacitance in each parity and accordingly compensating the circuit signals.

4. The structure according to claim 3, in which first and second parities form first and second capacitor on the top and the bottom surface of said base board respectively, in which the first capacitor is created by extending the first and the second parity on the top surface of the base board to form staggeringly disposed lead-wire wound patterns while the second capacitor is created by extending the first and the second parity on the bottom surface of the base board to form staggeringly disposed lead-wire wound patterns, namely, said first and said second parity form a horizontal capacitance structure on the top surface and the bottom surface of the base board respectively, and a vertical capacitance structure is also formed by the first and the second capacitor to thereby enhance the capacitance between the second parity and the third parity for compensating the circuit signals.
